(19) United States
(12) Patent Application Publication
(10) Pub. No.: US 2014/0178283 A1
(43) Pub. Date: Jun. 26, 2014

(54) HYDROGENATION OF ORGANOCHLOROSILANES AND SILICON TETRACHLORIDE

(71) Applicants: Norbert Schladerbeck, Kelkheim (DE); Ingo Pauli, Schmitten (DE); Guido Stochniol, Haltern am See (DE); Yücel Önal, Carl Junction, MO (US)

(72) Inventors: Norbert Schladerbeck, Kelkheim (DE); Ingo Pauli, Schmitten (DE); Guido Stochniol, Haltern am See (DE); Yücel Önal, Carl Junction, MO (US)

(73) Assignee: Evonik Degussa GmbH, Essen (DE)

(21) Appl. No.: 13/977,984

(22) PCT Filed: Dec. 20, 2011
(86) PCT No.: PCT/EP2011/073346

§ 371 Date: Sep. 13, 2013

(30) Foreign Application Priority Data
Jan. 4, 2011 (DE) 102011002436.0

(51) Int. Cl. C01B 33/107

(52) U.S. Cl. CPC C01B 33/1071
USPC 423/342

(57) ABSTRACT

The invention relates to a process for preparing trichlorosilane, characterized in that hydrogen and at least one organic chlorosilane are reacted in a reactor which is operated under superatmospheric pressure and comprises one or more reactor tubes which consist of a gastight ceramic material.

The invention relates to a process for preparing trichlorosilane, characterized in that hydrogen and at least one organic chlorosilane are reacted in a reactor which is operated under superatmospheric pressure and comprises one or more reactor tubes which consist of a gastight ceramic material.

Trichlorosilane (TCS) is an important raw material for the production of high-purity silicon which is required in the semiconductor and photovoltaics industry. The demand for TCS has risen continuously in recent years and the demand is predicted to continue to rise for the foreseeable future.

The deposition of high-purity silicon from TCS is carried out in a chemical vapour deposition (CVD) process by the Siemens process, in which, depending on the choice of process parameters, relatively large amounts of silicon tetrachloride (STC) are obtained as coproduct. The TCS used is usually obtained by a chlorosilane process, i.e. reaction of crude silicon with HCl at temperatures of about 300° C. in a fluidized-bed reactor or at about 1000° C. in a fixed-bed reactor, with the removal of other chlorosilanes formed as coproducts, e.g. STC, being carried out by subsequent distillation. Furthermore, organic impurities lead to formation of organic chlorosilanes as further by-products in the above processes. Large amounts of organic chlorosilanes such as methyltrichlorosilane (MTCS), methyldichlorosilane (MHDCS) or propyltrichlorosilane (PTCS) can also be prepared in a targeted manner from silicon and alkyl chlorides by the Müller-Rochow synthesis.

To cover the rising demand for TCS and improve the economics of processes for producing high-purity silicon, it is therefore necessary to have processes which allow efficient conversion of silicon tetrachloride and organochlorosilanes into TCS, so that the coproducts from the Siemens process and the chlorosilane process and also streams from the Müller-Rochow synthesis can be utilized for the production of high-purity silicon.

Various processes for the hydrodechlorination of STC to TCS are known. According to the industrial state of the art, a thermally controlled process in which the STC is introduced together with hydrogen into a graphite-lined reactor, known as the “Siemens furnace”, is used. The graphite rods present in the reactor are operated as resistance heating, so that temperatures of 1100° C. and higher can be achieved. The high temperature and the presence of hydrogen shift the equilibrium in the direction of the TCS product. The product mixture is discharged from the reactor after the reaction and fractionated in complicated processes. Continuous flow occurs through the reactor, with the interior surfaces of the reactor consisting of graphite as corrosion-resistant material. Metallic materials are not sufficiently corrosion resistant for direct contact with chlorosilanes at the high reaction temperatures. However, an outer shell of metal is used to stabilize the reactor. This outer wall has to be cooled in order to suppress, as far as possible, the decomposition reactions which occur at the hot reactor wall at the high temperatures, which can lead to silicon deposits.

Process improvements encompass, in particular, the use of carbon-based materials of construction having a chemically inert coating, in particular SiC, to avoid degradation of the material of construction and contamination of the product gas mixture due to reactions of the carbon-based material with the chlorosilane/H₂ gas mixture.

Thus, U.S. Pat. No. 5,906,799 proposes the use of SiC-coated carbon fibre composites which are additionally suitable for improving the tolerance of the reactor construction towards thermal shock.

DE 102005046703 A1 describes a process for the dehydrohalogenation of a chlorosilane, in which a graphitic heating element and the surface of the reaction chamber which come into contact with the chlorosilane are coated in-situ with a protective SiC layer by reaction of the graphite with organosilanes at temperatures above the reaction temperature of the dehydrohalogenation in a step preceding the dehydrohalogenation. The arrangement of the heating element in the interior of the reaction chamber increases the efficiency of energy input from the electric resistance heating.

In all the above processes, complicated coating processes are required. A further disadvantage is that the use of electric resistance heating as described is uneconomical compared to direct heating by means of natural gas. The undesirable deposits of silicon formed at the very high reaction temperature required also necessitate regular cleaning of the reactor. In addition, the metallic pressure reactor firstly has to be externally cooled in a complicated manner and lined on the inside by high-temperature thermal insulation, with the lining at the same time having to provide protection against corrosive attack.

A further disadvantage is the carrying out of a purely thermal reaction without a catalyst, which makes the above processes very inefficient overall. Accordingly, various processes for the catalytic dehydrohalogenation of STC have been developed.

For example, WO 2005/102927 A1 and WO 2005/102928 A1 describe the use of Ca, Sr, Ba or the chlorides thereof or a metallic heating element, in particular one composed of Nb, Ta, W or alloys thereof, as catalysts for the conversion of an H₂/SiCl₄ gas mixture into TCS with virtually thermodynamic degrees of conversion at temperatures of from 700 to 950° C. and pressures of from 1 to 10 bar in flow-through reactors made of fused silica.

Furthermore, an earlier patent application by the present inventors describes a process for the hydrodehalogenation of SiCl₄ to TCS in a reactor which is operated under superatmospheric pressure and comprises one or more reactor tubes which consist of a gastight ceramic material. The interior walls of the tube are preferably coated with a catalyst comprising at least one active component selected from among the metals Ti, Zr, Hf, Ni, Pd, Pt, Mo, W, Nb, Ta, Ba, Sr, Ca, Mg, Ru, Rh, Ir and combinations thereof and the silicide compounds thereof, with the tubes optionally being able to be filled with a fixed bed of packing elements which are made of the same ceramic material and are analogously coated with catalyst. The conversion into TCS occurs with a virtually thermodynamic degree of conversion and high selectivity at temperatures of about 900° C. The reaction temperatures can advantageously be generated by arrangement of the reactor tubes in a combustion chamber heated by combustion of natural gas.

The above-described processes are employed for the dehydrohalogenation of chlorosilanes, in particular STC. In view of the considerable amounts of organic chlorosilanes obtained as coproducts from the Siemens process or the chlorosilane process or especially as products of a Müller-Rochow synthesis, it would be very desirable to develop a process for utilizing these sources for the production of high-purity silicon, which process also allows efficient hydrogenation of organic chlorosilanes to TCS.

According to DE 4343169 A1, transition metals or silicides thereof are equally suitable as catalysts for the dehydrohalogenation of STC and for the hydrogenation of organochloro compounds. The process proposed using all-active catalysts. This means a relatively high consumption of material and incomplete utilization of the catalytically active components. In addition, carrying out the reaction in a flow-through reactor under atmospheric pressure results in a comparatively low space-time yield.

It was therefore an object of the present invention to provide an efficient and inexpensive process for reacting organic chlorosilanes with hydrogen to form trichlorosilane, which process makes a high space-time yield and selectivity to TCS possible.

To solve this problem, it has been found that a mixture of at least one organic chlorosilane and hydrogen can be passed through a tube-like reactor which is operated under superatmospheric pressure and can be provided with a catalytic wall coating and/or with a fixed-bed catalyst. According to the invention, particular preference is given to the reaction in the reactor being catalyzed by an interior coating in one or more reactor tubes which catalyzes the reaction. The reaction in the reactor can be additionally catalyzed by a coating which catalyzes the reaction on a fixed bed arranged in the reactor or in the one or more reactor tubes. The combination of use of a catalyst for improving the reaction kinetics and increasing the selectivity and also a reaction operated under superatmospheric pressure ensure an economically and ecologically very efficient process. It has here surprisingly been found that high conversions of organic chlorosilane compounds into TCS are possible in the reaction system according to the invention. Suitable setting of the reaction parameters such as pressure, residence time and molar ratios of the starting materials make it possible to provide a process in which high space-time yields of TCS are obtained together with a high selectivity. The mixture reacted in the reactor can optionally contain at least one organic chlorosilane and hydrogen as further starting material in addition to STC.

It has been found that reactor tubes made of particular gastight ceramic materials which are specified in more detail below can be used for the hydrogenation of chlorosilanes, in particular organochlorosilanes, since they are also sufficiently inert at the required reaction temperatures of above 700° C. and can ensure the pressure resistance of the reactor. The interior walls of the reactor tube(s) can, like the surface of any packing elements of the same ceramic material present in the interior of the tube, be provided with a catalytically active coating in a simple manner without special apparatus.

A further advantage of the use of reactor tubes made of ceramic materials which are also corrosion-resistant and gastight at high temperatures is the opportunity of heating by means of natural gas burners, as a result of which the required reaction heat can be introduced significantly more economically compared to electric resistance heating. In addition, the systems heated by fuel gas have a uniform temperature profile. Electric resistance heating, on the other hand, can display local overheating since the electric resistance cannot be maintained sufficiently uniformly due to geometric variations of the resistance-heated components or as a result of wear, so that local deposition occurs and costly shutdowns associated with cleaning result. Finally, compared to graphite-based hydrohalogenation reactors, it is not necessary to cool a metallic outer wall which has to be protected against corrosion.

The solution according to the invention to the abovementioned problem will be described in more detail below, including various or preferred embodiments.

The invention provides a process for preparing trichlorosilane, characterized in that hydrogen and at least one organic chlorosilane are reacted in a reactor which is operated under superatmospheric pressure and comprises one or more reactor tubes which consist of a gastight ceramic material.

In a specific embodiment of the process of the invention, silicon tetrachloride mixed with the at least one organic chlorosilane is additionally reacted with hydrogen to form trichlorosilane.

In these reactions of hydrogen with organochlorosilane(s), optionally in a mixture with STC, methyltrichlorosilane can, in particular embodiments, be used as sole organic chlorosilane. The expression “sole organic chlorosilane” here means that the accumulated molar amount of other organic chlorosilanes present in the reaction mixture is less than 3 mol % based on the molar amount of methyltrichlorosilane.

In all the abovementioned variants of the process of the invention, a hydrogen-containing feed gas and a feed gas containing at least one organic chlorosilane and also optionally a silicon tetrachloride-containing feed gas can be reacted in a reactor with supply of heat to form a trichlorosilane-containing product gas, with the organochlorosilane-containing feed gas and/or the hydrogen-containing feed gas and/or the silicon tetrachloride-containing feed gas being able to be conveyed as pressurized streams into the reactor operated under superatmospheric pressure and the product gas being conveyed as pressurized stream from the reactor. The product stream may comprise not only trichlorosilane and organic compounds which are formed by hydrogenolysis of Si—C bonds in the organochlorosilanes, for example alkanes in the case of alkylchlorosilanes, but also by-products such as HCl, tetrachlorosilane, dichlorosilane, monochlorosilane and/or silane and also further organic chlorosilanes and/or organosilanes different from the starting materials used. The product stream generally also contains as yet unreacted starting materials, i.e. the at least one organic chlorosilane, hydrogen and possibly silicon tetrachloride.

In all the above-described variants of the process of the invention, the organochlorosilane-containing feed gas and the hydrogen-containing feed gas and, if present, the silicon tetrachloride-containing feed gas can also be fed as a joint stream into the reactor which is operated under superatmospheric pressure.

In the process of the invention, the organochlorosilane-containing feed gas preferably contains organotrichlorosilanes of the formula RSiCl₃, where R is an alkyl group, in particular a linear or branched alkyl group having from 1 to 8 carbon atoms, e.g. methyl, ethyl, propyl, butyl, pentyl, hexyl, heptyl and octyl, a phenyl group or an aralkyl group, as a result of which high yields of the desired TCS product are made possible. Methyltrichlorosilane (MTCS), ethyltrichlorosilane (ETCS) and/or n-propyltrichlorosilane (PTCS) can particularly preferably be used as organochlorosilane in the process of the invention. These organic chlorosilanes can be taken either individually or as a mixture as, in particular, secondary streams from a chlorosilane process, high-purity silicon production by the Siemens process and/or a Müller-Rochow synthesis after appropriate product gas work-up.

In a particular embodiment, a silicon tetrachloride-containing feed gas is used in addition to the organochlorosilane-containing feed gas in the process of the invention. It is also possible to use a feed gas containing organochlorosilane and silicon tetrachloride. In these cases, the reaction with hydrogen in the reactor occurs by parallel hydrogenation of the at least one organochlorosilane and hydrodehalogenation of SiCl₄.

Silicon tetrachloride-containing feed gas can, in particular, be obtained from secondary streams from a chlorosilane process and/or high-purity silicon production by the Siemens process after appropriate product gas work-up.

Furthermore, the process of the invention can also be applied to the hydrogenation of disubstituted or higher-substituted organochlorosilanes of the formula RₓSiCl₄₋ₓ, where x=2, 3 or 4 and R=alkyl group, in particular having from 1 to 8 carbon atoms, phenyl group or aralkyl group, and/or organically substituted disilanes or higher silanes. However, the product mixture will in these cases have only a relatively small proportion of TCS. Here, predominantly chlorosilanes having a relatively high proportion of hydrogen or Si—Si bonds will be present in the product mixture.

The gastight ceramic material of which the one or more reactor tubes of the reactor consists is preferably selected from among SiC and Si₃N₄ and mixed systems (SiCN). Tubes made of these materials are sufficiently inert, corrosion-resistant and pressure-stable even at the high reaction temperatures of above 700° C. required, so that the TCS synthesis from organic chlorosilanes and optionally STC can be operated at a gauge pressure of several bar. In principle, gastight materials have to be used as reactor tube material. This also includes a possible use of suitable nonceramic materials such as fused silica.

Particular preference is given to reactors having SiC-containing reactor tubes, since this material has a particularly good thermal conductivity and thus makes uniform heat distribution and good heat input for the reaction possible. In a useful embodiment of the process of the invention, the gastight reactor tubes can, in particular, be composed of Si-infiltrated SiC (SiSiC) or pressureless sintered SiC (SSiC), without being restricted thereto. Commercial sources of special ceramics are, for example, Saint-Gobain Industriekeramik Rodental GmbH: tubes of the “Advancer®” type; Saint Gobain Ceramics “Hexoloy®”; MTC Haldenwanger “Halsic-I” and also SSiC from Schunk Ingenieurkeramik GmbH.

The corrosion resistance of the materials mentioned can be additionally increased by an SiO₂ layer having a layer thickness in the range from 1 to 100 μm. In a specific embodiment, reactor tubes made of SiC, Si₃N₄ or SiCN with an appropriate SiO₂ layer as coating are therefore used.

In a further variant of the process of the invention, at least one reactor tube can be filled with packing elements consisting of the same gastight ceramic material as the tube. This inert bed can serve to optimize the flow dynamics. As bed material, it is possible to use packing elements such as rings, spheres, rods or other suitable packing elements.

In a particularly preferred embodiment of the process of the invention, the interior walls of at least one reactor tube and/or at least part of the packing elements are coated with at least one material which catalyzes the reaction of hydrogen with organochlorosilane(s) and optionally silicon tetrachloride to form trichlorosilane. In general, the tubes can be used with or without catalyst, but the catalytically coated tubes represent a preferred embodiment since suitable catalysts lead to an increase in the reaction rate and thus to an increase in the space-time yield. If the packing elements are coated with a catalytically active coating, the catalytically active interior coating of the reactor tubes may be able to be dispensed with. However, in this case too, preference is given to the interior walls of the reactor tubes being included since the catalytically useful surface area is in this case increased compared to purely supported catalyst systems (e.g. per fixed bed).

The catalytically active coating(s), i.e. for the interior walls of the reactor tubes and/or any fixed bed used, preferably consist of a composition comprising at least one active component selected from among the metals Ti, Zr, Hf, Ni, Pd, Pt, Mo, W, Nb, Ta, Ba, Sr, Ca, Mg, Ru, Rh, Ir and combinations thereof and silicide compounds thereof, should these exist. Particularly preferred active components here are Pt, Pt/Pd, Pt/Rh and Pt/Ir.

The application of the catalytically active coating to the interior walls of the reactor tubes and/or any fixed bed used can comprise the following steps:
1. Provision of a suspension containing a) at least one active component selected from among the metals Ti, Zr, Hf, Ni, Pd, Pt, Mo, W, Nb, Ta, Ba, Sr, Ca, Mg, Ru, Rh, Ir and combinations thereof and silicide compounds thereof, b) at least one suspension medium and optionally c) at least one auxiliary component, in particular for stabilizing the suspension, for improving the storage stability of the suspension, for improving the adhesion of the suspension to the surface to be coated and/or for improving the application of the suspension to the surface to be coated.
2. Application of the suspension to the interior wall of the one or more reactor tubes and/or to the surface of the packing elements.
3. Drying of the applied suspension.
4. Heat treatment of the applied and dried suspension at a temperature in the range from 500° C. to 1500° C. under inert gas or hydrogen.

The heat-treated packing elements can then be introduced into the one or more reactor tubes. The heat treatment and optionally also the preceding drying can, however, also be carried out on packing elements which have already been introduced into the reactor tubes.

As suspension medium as per component b) of the suspension according to the invention, it is possible to use, in particular, suspension media having binder character, advantageously thermoplastic polymeric acrylate resins as are also used, for example, in the paint and varnishes industry. These include, for example, compositions based on polymethyl acrylate, polyethyl acrylate, polypropyl methacrylate and/or polybutyl acrylate. These are commercial systems as can be obtained, for example, under the trade names Degalan® from Evonik Industries.

Optionally, one or more auxiliary components can advantageously be used as further components, i.e. in the sense of component c).

Thus, it is possible to use solvents or diluents as auxiliary component c). Preferred auxiliary components are organic solvents, in particular aromatic solvents or diluents such as toluene, xylene, and also ketones, aldehydes, esters, alcohols or mixtures of at least two of the abovementioned solvents and diluents.

Stabilization of the suspension can, if necessary, advantageously be achieved by means of inorganic or organic rheological additives. Preferred inorganic rheological additives as component c) include, for example, kieselguhr, bentonites, smectites and attapulgites, synthetic sheet silicates, pyrogenic silica or precipitated silica. Organic rheological additives or auxiliary components c) preferably include castor oil and derivatives thereof, e.g. polyamide-modified castor oil, polyolefin or polyolefin-modified polyamide and polyamide and derivatives thereof, as are marketed, for example, under the trade name Luvotix®, and also mixed systems of inorganic and organic rheological additives.

As auxiliary component c) for improving the adhesion of the suspension to the surface to be coated, it is possible to use suitable binding agents selected from the group consisting of silanes and siloxanes. These include, by way of example but not exclusively, dimethyl polysiloxane, diethyl polysiloxane, dipropyl polysiloxane, dibutyl polysiloxane, diphenyl polysiloxane or mixed systems thereof, for example phenylethyl siloxanes or phenylbutyl siloxanes, or other mixed systems, and also mixtures thereof.

The suspension according to the invention can be obtained in a comparatively simple and economical way by, for example, mixing, stirring or kneading of the starting materials, i.e. the components a), b) and optionally c), in appropriate conventional apparatuses known to those skilled in the art.

The reaction in the process of the invention is typically carried out at a temperature in the range from 700° C. to 1000° C., preferably from 850° C. to 950° C. and/or a pressure in the range from 1 to 10 bar, preferably from 3 to 8 bar, particularly preferably from 4 to 6 bar, and/or in a gas stream. Temperatures above 1000° C. should be avoided in order to avoid uncontrolled deposition of silicon.

The molar ratio of hydrogen to the sum of organochlorosilane(s) and silicon tetrachloride should advantageously be set in the range from 1:1 to 8:1, preferably from 2:1 to 6:1, particularly preferably from 3:1 to 5:1, in particular 4:1.

The dimensions of the reactor tube and the design of the complete reactor are determined by the availability of the tube geometry and also by the requirements in respect of introducing the heat necessary for the reaction. It is possible for either a single reactor tube or else a combination of a plurality of reactor tubes to be arranged in a heating chamber. A further advantage of the use of pressure-stable and corrosion-resistant ceramic flow tubes is the possibility of direct or indirect heating by means of natural gas burners which supply the necessary energy input significantly more economically than electric power. However, the supply of heat for the reaction in the reactor can in principle be effected by means of electric resistance heating or combustion of a fuel gas such as natural gas. An advantage of the use of systems heated by means of fuel gas is the uniform temperature profile. Electric resistance heating can result in local overheating since the electric resistance cannot be maintained sufficiently uniformly due to geometric variations in the resistance-heated components or as a result of wear, so that deposition occurs and costly shutdowns associated with cleaning result. To avoid local temperature peaks at the reactor tubes in the case of heating by means of fuel gas, the burners should not be directed directly at the tubes. They can, for example, be distributed over the heating chamber and aligned in such a way that they point into the free space between parallel reactor tubes. The mechanical stability of the tubes made of the above-described ceramic materials is sufficiently high for pressures of a number of bar, preferably in the range 1-10 bar, particularly preferably in the range 3-8 bar, particularly preferably 4-6 bar, to be set. In contrast to previously described reactors having a graphite-based lining of the reaction spaces, there is no need for a metallic wall which has to be cooled and protected against corrosion.

To increase the energy efficiency, the reactor system can be connected to a heat recovery system. In a particular embodiment, one or more of the reactor tubes are for this purpose closed at one end and each contain a gas-introducing inner tube which preferably consists of the same material as the reactor tubes. Flow reversal occurs between the closed end of the respective reactor tube and the opening of the interior tube which faces this closed end. In this arrangement, heat is in each case transferred from product gas mixture flowing between the interior wall of the reactor tube and the outer wall of the inner tube to feed gas flowing through the inner tube by means of heat conduction through the ceramic inner tube. The integrated heat-exchange tube can also be at least partly coated with above-described catalytically active material.

The following examples illustrate the process of the invention, but do not constitute any restriction.

### EXAMPLES

### Example 1

Production of the Catalyst Paste, Example According to the Invention

In a mixed vessel, a mixture of 54% by weight of toluene, 0.3% by weight of Aerosil R 974, 6.0% by weight of phenylethylpolysiloxane, 16.8% by weight of aluminium pigment Reflaxal, 10.7% by weight of Degalan LP 62/03 solution and 12.2% by weight of tungsten silicide was intensively mixed.

### Example 2

Application of the Catalyst Paste, Example According to the Invention

A ceramic tube made of silicon carbide (SSiC) was coated with the formulation described in Example 1 by introducing the catalyst mixture into the reaction tube. The mixture was uniformly distributed by shaking the tube closed with stoppers, and then dried overnight in air. The tube had an internal diameter of 15 mm and a total length of 120 cm. The isothermally heated zone was 40 cm.

### Example 3

Catalyst Activation and Hydrogenation, Examples According to the Invention

The reactor tube was installed in an electrically heatable tube furnace. The tube furnace with the respective tube was firstly brought to 900° C., with nitrogen at 3 bar absolute being passed through the reaction tube. After two hours, the nitrogen was replaced by hydrogen. After a further hour in the stream of hydrogen, likewise at 3.6 bar absolute, methyltrichlorosilane or a mixture of methyltrichlorosilane with silicon tetrachloride from Aldrich was pumped into the reaction tube. The temperature in the tube furnace had already been set at 900° C. when changing from nitrogen to feed. The stream of hydrogen was set to a molar excess of 4:1. The reactor output was analyzed by on-line gas chromatography and the amounts of trichlorosilane, silicon tetrachloride, dichlorosilane and methyldichlorosilane formed were calculated therefrom. Calibration of the gas chromatograph was carried out using the pure substances.

The hydrogen chloride formed or other by-products were not evaluated. The results are shown in Table 1.

TABLE 1
Results of the catalytic reaction of MTCS, optionally
in admixture with STC, with hydrogen

| | | | MTCS | DCS | TCS | STC | MHDCS |
|---|---|---|---|---|---|---|---|
| MTCS | STC | | in the | in the | in the | in the | in the |
| in the | in the | Furnace | product | product | product | product | product |
| feed | feed | temperature | [% by | [% by | [% by | [% by | [% by |
| [ml/h] | [ml/h] | [° C.] | weight] | weight] | weight] | weight] | weight] |
| 78.0 | 0.0 | 900 | 13.9 | 2.4 | 37.4 | 45.1 | 1.1 |
| 156.0 | 0.0 | 900 | 25.1 | 2.3 | 35.8 | 34.8 | 1.9 |
| 78.0 | 0.0 | 950 | 7.6 | 2.2 | 36.5 | 52.2 | 0.82 |
| 39.0 | 39.0 | 950 | 1.6 | 0.33 | 22.2 | 71.4 | 0.10 |

STC = Silicon tetrachloride
TCS = Trichlorosilane
DCS = Dichlorosilane
MHDCS = Methyldichlorosilane

1. A process for preparing trichlorosilane, comprising reacting hydrogen and an organic chlorosilane in a reactor, wherein the reactor is operated under superatmospheric pressure and comprises a reactor tube comprising a gastight ceramic material.

2. The process according to claim 1, wherein silicon tetrachloride is mixed with the organic chlorosilane, which is additionally reacted with hydrogen to form trichlorosilane.

3. The process according to claim 1, wherein methyltrichlorosilane is the sole organic chlorosilane.

4. The process according to claim 1, wherein the reacting comprises reacting a feed gas comprising hydrogen, a feed gas comprising an organic chlorosilane, and optionally a feed gas comprising silicon tetrachloride in a reactor with supply of heat to form a product gas comprising trichlorosilane, in which the feed gas comprising organochlorosilane, the feed gas comprising hydrogen, the feed gas comprising silicon tetrachloride, or any combination thereof, are able to be conveyed as pressurized streams into the reactor operated under superatmospheric pressure, and the product gas is conveyed as pressurized stream from the reactor.

5. The process according to claim 4, wherein the feed gas comprising organochlorosilane, the feed gas comprising hydrogen, and, if present, the feed gas comprising silicon tetrachloride, are introduced in a joint stream into the reactor which is operated under superatmospheric pressure.

6. The process according to claim 1, wherein a molar ratio of hydrogen to a sum of organochlorosilane and silicon tetrachloride is of from 1:1 to 8:1.

7. The process according to claim 1, wherein the reacting is carried out at a pressure of from 1 to 10 bar, a temperature of from 700° C. to 1000° C., in a gas stream, or any combination thereof.

8. The process according to claim 1, wherein a supply of heat for the reacting in the reactor is effected by electric resistance heating or combustion of a fuel gas.

9. The process according to claim 1, wherein the reactor tube comprises a gastight ceramic material selected from the group consisting of SiC, Si₃N₄, and a mixed system (SiCN) thereof.

10. The process according to claim 9, wherein the gastight ceramic material is selected from the group consisting of Si-infiltrated SiC (SiSiC) and pressureless sintered SiC (SSiC).

11. The process according to claim 1, wherein the reactor tube is closed at one end and comprises a gas-introducing inner tube.

12. The process according to claim 1, wherein the reactor tube is filled with a packing element comprising the same gastight ceramic material as the tube.

13. The process according to claim 1, wherein an interior wall of the reactor tube, at least part of a packing element of the reactor tube, or both, are coated with a material which catalyzes the reacting of hydrogen with organochlorosilane and optionally silicon tetrachloride to form trichlorosilane.

14. The process according to claim 13, wherein the material is a catalytically active coating comprising at least one active metal selected from the group consisting of Ti, Zr, Hf, Ni, Pd, Pt, Mo, W, Nb, Ta, Ba, Sr, Ca, Mg, Ru, Rh, Ir and a silicide compound thereof.

15. The process according to claim 13, wherein the catalytically active coating is applied by a process comprising:
applying a suspension to an interior wall of a reactor tube, to a surface a surface of the packing element, or both,
wherein the suspension comprises:
at least one active metal selected from the group consisting of Ti, Zr, Hf, Ni, Pd, Pt, Mo, W, Nb, Ta, Ba, Sr, Ca, Mg, Ru, Rh, Ir and a silicide compound thereof,
a suspension medium, and
optionally an auxiliary component for stabilizing the suspension, for improving storage stability of the suspension, for improving the adhesion of the suspension to a surface to be coated, for improving the applying of the suspension to the surface to be coated, or any combination thereof;
drying of the applied suspension;
treating with heat the applied and dried suspension at a temperature of from 500° C. to 1500° C. under inert gas or hydrogen;
optionally introducing the heat-treated packing element into the reactor tube, with the heat treating; and
optionally drying the packing element which has already been introduced into the reactor tubes.

16. The process according to claim 1, wherein a molar ratio of hydrogen to a sum of organochlorosilane and silicon tetrachloride is of from 2:1 to 6:1.

17. The process according to claim 1, wherein a molar ratio of hydrogen to a sum of organochlorosilane and silicon tetrachloride is of from 3:1 to 5:1.

18. The process according to claim 1, wherein a molar ratio of hydrogen to a sum of organochlorosilane and silicon tetrachloride is 4:1.
